(19) United States
(12) Patent Application Publication
(10) Pub. No.: US 2024/0397451 A1
(43) Pub. Date: Nov. 28, 2024

(54) SIGNALING CLOSED-LOOP POWER CONTROL FOR SINGLE AND MULTIPLE TRANSMISSION/RECEPTION POINTS (TRPS)

(71) Applicant: Telefonaktiebolaget LM Ericsson (publ), Stockholm (SE)

(72) Inventors: Shiwei GAO, Nepean (CA); Siva MURUGANATHAN, Stittsville (CA)

(21) Appl. No.: 18/262,445

(22) PCT Filed: Jan. 21, 2022
(86) PCT No.: PCT/IB2022/050564

§ 371 Date: Jul. 21, 2023

Related U.S. Application Data
(60) Provisional application No. 63/141,336, filed on Jan. 25, 2021.

(51) Int. Cl. H04W 52/58; H04W 52/08; H04W 72/232

(52) U.S. Cl. CPC H04W 52/58; H04W 52/08; H04W 72/232

(57) ABSTRACT

A method, network node and wireless device for signaling closed-loop power control for single and multiple transmission/reception points (TRPs) are disclosed. According to one aspect. a method in a network node includes generating at least one a first downlink control information (DCI) message with a first transmit power control (TPC) command field of N bits configured to schedule a physical uplink shared (PUSCH) transmission and a second DCI message with a second TPC command field of M bits configured to schedule a physical downlink shared channel. PDSCH. transmission.

### TECHNICAL FIELD

The present disclosure relates to wireless communications, and in particular, to signaling closed-loop power control for single and multiple transmission/reception points (TRPs) in a wireless communication network.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### NR Frame Structure and Resource Grid

NR uses CP-OFDM (Cyclic Prefix Orthogonal Frequency Division Multiplexing) in both the downlink (DL) (i.e., from a network node, gNB, or base station, to a user equipment, wireless device or WD) and the uplink (UL) (i.e., from WD to network node). Discrete Fourier Transform (DFT) spread OFDM is also supported in the uplink. In the time domain, NR downlink and uplink transmissions are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis. An example is shown in FIG. 1 with a 14-symbol slot, where the first two symbols contain a physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ ∈{0,1,2,3,4}. Δf=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each RB corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink (DL) PDSCH transmissions can be either dynamically scheduled, i.e., in each slot, and the network node transmits downlink control information (DCI) over the PDCCH (Physical Downlink Control Channel) about which WD data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, uplink (UL) PUSCH transmission can also be scheduled either dynamically or semi-persistently with uplink grants carried in PDCCH. NR supports two types of semi-persistent uplink transmission, i.e., type 1 configured grant (CG) and type 2 configured grant, where the Type 1 configured grant is configured and activated by Radio Resource Control (RRC), while the type 2 configured grant is configured by RRC, but activated/deactivated by DCI. The DCI formats for scheduling PUSCH include DCI format 0_0, DCI format 0_1, and DCI format 0_2.

### Transmission with Multiple Beams

In the high frequency range (FR2), multiple radio frequency (RF) beams may be used to transmit and receive signals at a network node and a WD. For each DL beam from a network node, there is typically an associated best WD receive (Rx) beam for receiving signals from the DL beam. The DL beam and the associated WD Rx beam forms a beam pair. The beam pair can be identified through a so-called beam management process in NR.

A DL beam is identified by an associated DL reference signal (RS) transmitted in the beam, either periodically, semi-persistently, periodically. The DL RS for this purpose can be a Synchronization Signal (SS) and Physical Broadcast Channel (PBCH) block (SSB) or a Channel State Information RS (CSI-RS). For each DL RS, a WD can do a Rx beam sweep to determine the best Rx beam associated with the DL beam. The best Rx beam for each DL RS is then memorized by the WD. By measuring all of the DL RSs, the WD can determine and report to the network node the best DL beam to use for DL transmissions.

With the reciprocity principle, the same beam pair can also be used in the UL to transmit an UL signal to the network node, which is often referred to as beam correspondence.

An example is shown in in FIG. 3, where a network node consists of a transmission point (TRP) with two DL beams each associated with a CSI-RS and one SSB beam. Each of the DL beams is associated with a best WD Rx beam, i.e., Rx beam #1 is associated with the DL beam with CSI-RS #1 and Rx beam #2 is associated with the DL beam with CSI-RS #2.

Due to WD movement or change in environment, the best DL beam for a WD may change over time and different DL beams may be used in different times. The DL beam used for a DL data transmission in PDSCH can be indicated by a transmission configuration indicator (TCI) field in the corresponding DCI scheduling the PDSCH or activating the PDSCH in case of SPS. The TCI field indicates a TCI state which contains a DL RS associated with the DL beam. In the DCI, a PUCCH resource is indicated for carrying the corresponding hybrid automatic repeat request (HARQ) acknowledgment/non-acknowledgment (A/N). The UL beam for carrying the PUCCH is determined by a PUCCH spatial relation activated for the PUCCH resource. For PUSCH transmission, the UL beam is indicated indirectly by a sounding reference signal (SRS) resource indicator (SRI), which points to one or more SRS resources associated with the PUSCH transmission. The SRS resource(s) can be periodic, semi-persistent, or aperiodic. Each SRS resource is associated with a SRS spatial relation in which a DL RS (or another periodic SRS) is specified. The UL beam for the PUSCH is implicitly indicated by the SRS spatial relation(s).

### Spatial Relations

Spatial relation is used in NR to refer to a spatial relationship between an UL channel or signal, such as PUCCH, PUSCH and SRS, and a DL (or UL) reference signal (RS),such as CSI-RS, SSB, or SRS. If an UL channel or signal is spatially related to a DL RS, it means that the WD should transmit the UL channel or signal with the same beam used in receiving the DL RS previously. More precisely, the WD should transmit the UL channel or signal with the same spatial domain transmission filter used for the reception of the DL RS.

If an UL channel or signal is spatially related to an UL SRS, then the WD should apply the same spatial domain transmission filter for the transmission for the UL channel or signal as the one used to transmit the SRS.

For the PUCCH, up to 64 spatial relations can be configured for a WD and one of the spatial relations is activated by a Medium Access Control (MAC) Control Element (CE) for each PUCCH resource.

FIG. 4 is an example of a PUCCH spatial relation information element (IE) by which a WD can be configured in NR: the example includes one of an SSB index, a CSI-RS resource identity (ID), and SRS resource ID as well as some power control parameters such as pathloss RS, closed-loop index, etc.

For each periodic and semi-persistent SRS resource or aperiodic SRS with usage “non-codebook” configured, its associated DL CSI-RS is radio resource control (RRC) configured. For each aperiodic SRS resource with usage “codebook” configured, the associated DL RS is specified in a SRS spatial relation activated by a MAC CE. An example is shown in FIG. 5, where one of an SSB index, a CSI-RS resource identity (ID), and SRS resource ID is configured.

For PUSCH, its spatial relation is defined by the spatial relation of the corresponding SRS resource(s) indicated by the SRI in the corresponding DCI.

### Uplink Power Control in NR

Uplink power control is used to determine a proper transmit power for PUSCH, PUCCH and SRS to ensure that they are received by the network node at an appropriate power level. The transmit power will depend on the amount of channel attenuation, the noise and interference level at the network node receiver, and the data rate in case of PUSCH or PUCCH.

The uplink power control in NR consists of two parts: open-loop power control and closed-loop power control. Open-loop power control is used to set the uplink transmit power based on the pathloss estimation and some other factors including the target receive power, channel/signal bandwidth, modulation and coding scheme (MCS), fractional power control factor, etc.

Closed-loop power control is based on explicit power control commands received from the network node. The power control commands are typically determined based on some UL measurements at the network node of the actual received power. The power control commands may contain the difference between the actual and the target received powers. Either cumulative or non-cumulative closed-loop power adjustments are supported in NR. Up to two closed loops can be configured in NR for each UL channel or signal. A closed loop adjustment at a given time is also referred to as a power control adjustment state.

With multi-beam transmission in FR2, pathloss estimation should also reflect the beamforming gains corresponding to an uplink transmit and receive beam pair used for the UL channel or signal. This is achieved by estimating the pathloss based on measurements on a downlink RS transmitted over the corresponding downlink beam pair. The DL RS is referred to as a DL pathloss RS. A DL pathloss RS can be a CSI-RS or SSB. For the example shown in FIG. 3, when an UL signal is transmitted in beam #1, CSI-RS #1 may be configured as the pathloss RS. Similarly, if an UL signal is transmitted in beam #2, CSI-RS #2 may be configured as the pathloss RS. For an UL channel or signal (e.g., PUSCH, PUCCH, or SRS) to be transmitted in an UL beam pair associated with a pathloss RS with index k, its transmit power in a transmission occasion i within a slot in a bandwidth part (BWP) of a carrier frequency of a serving cell and a closed-loop index l (l=0,1) can be expressed as:

$$P ( i , k , l ) = min \{ \begin{matrix}{P}_{CMAX} ( i ) \\ {P}_{open - loop} ( i , k ) + {P}_{closed - loop} ( i , l )\end{matrix}$$

In this expression, P_{CMAX}(i) is the configured WD maximum output power for the carrier frequency of the serving cell in transmission occasion i for the UL channel or signal. Pₒₚₑₙ₋ₗₒₒₚ(i, k) is the open loop power adjustment and P_{closed-loop}(i, l) is the closed loop power adjustment. Pₒₚₑₙ₋ₗₒₒₚ(i, k) is given below:

$${P}_{open - loop} ( i , k ) = {P}_{O} + {P}_{RB} ( i ) + α PL ( k ) + Δ ( i )$$

where P_{O} is the nominal target receive power for the UL channel or signal and comprises a cell specific part P_{O,cell} and a WD specific part P_{O,UE}; P_{RB}(i) is a power adjustment related to the number of RBs occupied by the channel or signal in a transmission occasion i; PL(k) is the pathloss estimation based on a pathloss reference signal with index k; α is fractional pathloss compensation factor; and Δ(i) is a power adjustment related to MCS. P_{closed-loop}(i, l) is given below:

$${P}_{closed - loop} ( i , l ) = \{ \begin{matrix}{P}_{closed - loop} ( i - {i}_{0} , l ) + {\sum }_{m = 0}^{M} δ ( m , l ) ; if cumulation is enabled \\ δ ( i , l ) ; if cumulation is disabled ( i . e . , absolute is enable )\end{matrix}$$

Here, δ(i, l) is a transmit power control (TPC) command value included in a DCI format associated with the UL channel or signal at transmission occasion i and closed-loop l; Σₘ₌₀^{M}δ(m, l) is a sum of TPC command values that the WD receives for the channel or signal and the associated closed-loop l since the TPC command for transmission occasion i−i₀.

Note that power control parameters P_{O}, P_{RB}(i), α, PL, Δ(i), δ(i, l) are generally configured separately for each UL channel or signal (e.g., PUSCH, PUCCH, and SRS) and may be different for different UL channels or signals.

### Power Control for PUSCH

For PUSCH, P_{O}=P_{O,nominal_PUSCH}+P_{O,UE_PUSCH}, where P_{O,nominal_PUSCH} is cell specific and is RRC configured, and P_{O,UE_PUSCH} is WD specific and can be dynamically selected. For dynamically scheduled PUSCH, as illustrated in the example of FIG. 6, a WD is configured by RRC with a list of P0-PUSCH-Alpha sets and a list of SRI-PUSCH-PowerControl information elements. One SRI-PUSCH-PowerControl is selected by the SRI field in DCI (e.g., DCI formats 0_1, 0_2). Each SRI-PUSCH-PowerControl IE consists of a PUSCH pathloss RS ID, a closed-loop index, and a P0-PUSCH-AlphaSet ID. A P0-PUSCH-AlphaSet includes a P_{O,UE_PUSCH} and α. The value δ(i, l) is indicated in a 2-bit transmit power control (TPC) command field of the same downlink control information (DCI), where the mapping between the field value and the dB value is shown in Table 1.

For PUSCH, P_{O}=P_{O,nominal_PUSCH}+P_{O,UE_PUSCH}, where P_{O,nominal_PUSCH} is cell specific and is RRC configured, and P_{O,UE_PUSCH} is WD specific and can be dynamically selected. For dynamically scheduled PUSCH, as illustrated in FIG. 6, a WD is configured by RRC with a list of P0-PUSCH-Alpha sets and a list of SRI-PUSCH-PowerControl information elements. One SRI-PUSCH-PowerControl is selected by the SRI field in DCI (e.g., DCI formats 0_1, 0_2). Each SRI-PUSCH-PowerControl IE consists of a PUSCH pathloss RS ID, a closed-loop index, and a P0-PUSCH-AlphaSet ID. A P0-PUSCH-AlphaSet includes a P_{O,UE_PUSCH} and α. The value δ(i, l) is indicated in a 2-bit TPC command field of the same DCI, where the mapping between the field value and the dB value is shown in Table 1 below.

In 3GPP NR Technical Release 16 (3GPP Rel-16), an additional one or two sets of P0-PUSCH-r16 can be configured for each SRI for ultra-reliable and low latency communication (URLLC) traffic. One set can be configured if SRI is present in UL DCI format 0_1 or DCI format 0_2 and whether the P0 associated with the SRI or the set of P0 configured for URLLC should be used for a PUSCH can be dynamically indicated in a “Open-loop power control parameter set indication” field in UL DCI. Two sets can be configured if SRI is not present in UL DCI and one of the two P0-PUSCH-r16 sets and the first P0-PUSCH-AlphaSet can be dynamically indicated in the “Open-loop power control parameter set indication” field in UL DCI.

If the PUSCH transmission is scheduled by a DCI format that does not include a SRI field, or if SRI-PUSCHPowerControl is not provided to the WD, the WD determines P_(O,UE_PUSCH) and a from the value of the first P0-PUSCH-AlphaSet.

In addition to the TPC command field in DCI that schedules a PUSCH, PUSCH power control for a group of WDs is also supported by DCI format 2_2 with a cyclic redundancy code (CRC) scrambled by TPC-PUSCH-RNTI, in which power adjustments for multiple WDs can be signaled simultaneously.

TABLE 1
Mapping of TPC Command Field in DCI formats 0_0, 0_1,
0_2, 2_2 for PUSCH or DCI format 2_3 for SRS to
absolute and accumulated values

| | Accumulated δ(m, l) | Absolute δ (m, l) |
|---|---|---|
| TPC Command Field | [dB] | [dB] |
| 0 | −1 | −4 |
| 1 | 0 | −1 |
| 2 | 1 | 1 |
| 3 | 3 | 4 |

For PUSCH with configured grant, P_{O}, α and a closed loop index are semi-statically configured by RRC. For a configured grant (CG) with RRC configured pathloss RS, the RS is used for pathloss estimation. Otherwise, the pathloss RS indicated in the DCI activating the CG PUSCH is used for pathloss estimation.

Default pathloss RS:

If the PUSCH transmission is scheduled by a DCI format 0_0, and if the WD is configured with PUCCH-SpatialRelationInfo for a PUCCH resource with a lowest index in the BWP of the serving cell, the WD uses the same pathloss RS resource for PUSCH as for a PUCCH transmission in the PUCCH resource with the lowest index.

If the SRI field is not present in a DCI format 0_1 or DCI format 0_2 scheduling a PUSCH, or SRI-PUSCH-PowerControl is not provided to the WD, or a PUSCH scheduled by DCI format 0_0 and PUCCH-SpatialRelationInfo is not configured, the pathloss RS is the one contained in the PUSCH-PathlossReferenceRS-Id with the lowest index value.

If the PUSCH transmission is scheduled by a DCI format 0_0, and if the WD is not configured with PUCCH-SpatialRelationInfo for a PUCCH resource, and if the WD is configured with enableDefaultBeamPlForPUSCH0_0, the WD in the BWP of the serving cell, the pathloss RS is then a periodic RS resource with ‘QCL-TypeD’ in a TCI state or QCL assumption of a CORESET with the lowest index in the active DL BWP of the primary cell.

### Power Control for PUCCH

For PUCCH, P_{O}=P_{O,nominal_PUCCH}+P_{O,UE_PUCCH} and α=1, where P_{O,nominal_PUCCH} is an RRC configured cell specific parameter and P_{O,UE_PUCCH} is a WD specific parameter and can vary among different PUCCH resources. A WD is configured with a list of up to 8 P_{O,UE_PUCCH} (each with a P0-PUCCH-Id) and a list of up to 8 pathloss RS (each with a pucch-PathlossReferenceRS-Id). For each PUCCH resource, a PUCCH spatial relation (i.e., PUCCH-SpatialRelationInfo) is activated in which a closed-loop index, a pathloss RS (from the corresponding list), and a P_{O,UE_PUCCH} (from the corresponding list) are configured.

For closed loop power adjustment for PUCCH, up to two control loops may be configured. Accumulation is always enabled. The TPC command for PUCCH HARQ A/N can be received in either DCI formats 1_0, 1_1 and 1_2 scheduling the corresponding PDSCH or in DCI format 2_2 when the DCI is scrambled with TPC-PUCCH-RNTI. The mapping between a TPC field value in DCI and a power correction value in dB is shown in Table 1.

TABLE 1
Mapping of TPC Command Field in DCI format 1_0
or DCI format 1_1 or DCI format 1_2 or DCI format
2_2 to accumulated δ(m, l) values for PUCCH.

| TPC Command Field | Accumulated δ(m, l) [dB] |
|---|---|
| 0 | −1 |
| 1 | 0 |
| 2 | 1 |
| 3 | 3 |

### Default Pathloss RS:

If the PUCCH spatial relation is not configured but a list of pathloss RS is configured for PUCCH, then the pathloss RS in the first one in the list is used.

If both the list of pathloss RS and PUCCH-SpatialRelationInfo are not configured, but the WD is configured with enableDefaultBeamPlForPUCCH, then the pathloss RS is a periodic RS resource with quasi-colocation, ‘QCL-TypeD’ in the TCI state of a control resource set (CORESET) with the lowest index in the active DL BWP of the primary cell.

### UL Transmission to Multiple Transmission Points (TRPs)

PDSCH transmission with multiple transmission points has been introduced in 3GPP NR Rel-16, in which a transport block may be transmitted over multiple TRPs to improve transmission reliability.

The introduction of an UL enhancement with multiple TRPs by transmitting a PUCCH or PUSCH toward two different TRPs is shown in FIG. 7, either simultaneously or in different times is proposed in 3GPP NR Rel-17.

In one scenario, multiple PUCCH/PUSCH transmissions each toward a different TRP may be scheduled by a single DCI. For example, multiple spatial relations may be activated for a PUCCH resource and the PUCCH resource may be signaled in a DCI scheduling a PDSCH. The HARQ A/N associated with the PDSCH is then carried by the PUCCH which is then repeated multiple times either within a slot or over multiple slots, each repetition being toward a different TRP. An example is shown in FIG. 8, where a PDSCH is scheduled by a DCI and the corresponding HARQ A/N is sent in a PUCCH which is repeated twice in time, one toward TRP #1 and the other toward TRP #2. Each TRP is associated with a PUCCH spatial relation.

An example of PUSCH repetitions is shown in FIG. 9, where two PUSCH repetitions for a same transport block (TB) are scheduled by a single DCI, each PUSCH occasion being toward a different TRP. Each TRP is associated with an SRI or an UL TCI state signaled in the UL DCI. It has been considered by 3GPP NR Rel-17 that two SRS resource sets can be configured and two SRIs can be indicated for PUSCH repetition to multiple TRPs.

To support power control for PUCCH and PUSCH transmitted to two TRPs, joint encoding of two TPC commands, one each for the two TRPs, in a single TPC field in a DCI has been proposed. If the same 2 bit TPC field is used for the joint encoding for two TRPs, only 4 possible combinations of power corrections can be supported. An example is shown in Table 3 below, where only two TPC values a and b can be indicated to a WD for power correction for each TRP. Thus, the power correction is coarse compared to the power correction used in existing PUCCH/PUSCH transmission to a single TRP.

To support dynamic switching between PUCCH transmission to a single and to two TRPs, a same DCI format 1_1 or DCI format 1_2 would be used. Similarly, to support dynamic switching between PUSCH transmission to a single and to two TRPs, a same DCI format 0_1 or DCI format 0_2 would be used. With the joint encoding proposal shown in Table 3 below, if a PUCCH/PUSCH is transmitted to a single TRP, the same coarse power correction would be used. Hence, finer power correction, which may be needed in the multi-TRP scenario, may not be achieved with the joint encoding proposal shown in Table 3.

TABLE 3

TPC value

| Code point in the TPC field with 2 bits | TRP#1 | TRP#2 |
|---|---|---|
| 0 | a | a |
| 1 | a | b |
| 2 | b | a |
| 3 | b | b |

### SUMMARY

Some embodiments advantageously provide methods, systems, and apparatuses for signaling closed-loop power control for single and multiple transmission/reception points (TRPs) in a wireless communication network.

In some embodiments, there is a single TPC command field in a DCI for scheduling PUCCH or PUSCH to both single and multiple TRPs, where different TPC encodings or mapping tables are used in the TPC command field in the DCI depending on whether the associated PUCCH or PUSCH transmission is to a single TRP and two multiple TRPs.

In case of transmission to a single TRP, in some embodiments, the TPC field may be encoded for a single TPC command, i.e., each code point is mapped to one TPC value and different code points are mapped to different values. . . . Otherwise if the transmission is to two TRPs, two TPC commands m encoded in the TPC field, i.e., each code point is mapped to two TPC values, one for each TRP.

The solution enables more accurate, or finer granularity power control, when a PUCCH or PUSCH is transmitted to a single TRP when a same DCI is used for PUCCH or PUSCH transmission to both single TRP and multiple TRPs.

According to one aspect, a network node configured to communicate with a wireless device includes: processing circuitry configured to generate at least one of: a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field in the first DCI; and (2) one of a second SRI field and a second TPMI field comprised in the first DCI; and a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource. The network node includes a radio interface (62) in communication with the processing circuitry and configure to transmit at least one the first DCI message and the second DCI message; and receive at least one of (1) the PUSCH transmission according to a first single TPC command carried in the first TPC command field; and (2) the uplink transmission of HARQ-ACK in the PUCCH resource according to a second single TPC command carried in the second TPC command field.

According to this aspect, in some embodiments, the PUSCH transmission corresponding to both the first SRI field and the second SRI field are according to the first single TPC command carried in the first TPC command field. In some embodiments, the PUSCH transmission corresponding to only the first SRI field are according to the first single TPC command carried in the first TPC command field. In some embodiments, the PUSCH transmission corresponding to both the first TPMI field and the second TPMI field is according to the first single TPC command carried in the first TPC command field. In some embodiments, the PUSCH transmission corresponding to only the first TPMI field is according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

According to another aspect, a method in a network node configured to communicate with a wireless device includes: generating at least one of: a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field in the first DCI; and (2) one of a second SRI field and a second TPMI field comprised in the first DCI; a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource. The method also includes transmitting at least one of the first DCI message and the second DCI message; and receiving at least one of (1) the PUSCH transmission according to a first single TPC command carried in the first TPC command field; and (2) the uplink transmission of HARQ-ACK in the PUCCH resource according to a second single TPC command carried in the second TPC command field.

According to this aspect, in some embodiments, the PUSCH transmission corresponding to both the first SRI field and the second SRI field are according to the first single TPC command carried in the first TPC command field. In some embodiments, the PUSCH transmission corresponding to only the first SRI field are according to the first single TPC command carried in the first TPC command field. In some embodiments, the PUSCH transmission corresponding to both the first TPMI field and the second TPMI field is according to the first single TPC command carried in the first TPC command field. In some embodiments, the PUSCH transmission corresponding to only the first TPMI field is according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

According to yet another aspect, a wireless device, configured to communicate with a network node, includes: a radio interface configured to receive at least one of: a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field comprised in the first DCI; and (2) one of a second SRI field and a second TPMI field comprised in the first DCI; and a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD (22) corresponding to at least one of (1) one spatial relation that is one of configured or activated for the PUCCH resource; and (2) two spatial relations that are one of configured and activated for the PUCCH resource; and the radio interface being further configured to: receive at least one of the first DCI message and the second DCI message; and transmit at least one of (1) the PUSCH transmission according to a first single TPC command carried in the first TPC command field; and (2) the uplink transmission of HARQ-ACK in the PUCCH resource according to a second single TPC command carried in the second TPC command field. In some embodiments, the PUSCH transmission corresponding to both the first SRI field and the second SRI field are according to the first single TPC command carried in the first TPC command field. In some embodiments, the PUSCH transmission only corresponding to the first SRI field are according to the first single TPC command carried in the first TPC command field. In some embodiments, the PUSCH transmission corresponding to both the first TPMI field and the second TPMI field are according to the first single TPC command carried in the first TPC command field. In some embodiments, the PUSCH transmission only corresponding to the first TPMI field are according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

According to another aspect, a method in a wireless device configured to communicate with a network node, includes receiving at least one of: a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field comprised in the first DCI; and (2) one of a second SRI field and a second TPMI field comprised in the first DCI; a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource. The method also includes receiving at least one of the first DCI message and the second DCI message; and transmitting at least one of (1) the PUSCH transmission according to a first single TPC command carried in the first TPC command field; and (2) the uplink transmission of HARQ-ACK in the PUCCH resource according to a second single TPC command carried in the second TPC command field.

According to this aspect, in some embodiments, the PUSCH transmission corresponding to both the first SRI field and the second SRI field are according to the first single TPC command carried in the first TPC command field. In some embodiments, the PUSCH transmission only corresponding to the first SRI field are according to the first single TPC command carried in the first TPC command field. In some embodiments, the PUSCH transmission corresponding to both the first TPMI field and the second TPMI field are according to the first single TPC command carried in the first TPC command field. In some embodiments, the PUSCH transmission only corresponding to the first TPMI field are according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of a NR time-domain structure with 15kHz subcarrier spacing;

FIG. 2 is an example of a NR physical resource grid;

FIG. 3 is an example of transmission and reception with multiple beams;

FIG. 4 is an example of PUCCH spatial relation information element;

FIG. 5 is an example of a SRS spatial relation information element;

FIG. 6 is an example of signaling of PUSCH power control parameters;

FIG. 7 is an example of PUCCH/PUSCH transmission toward multiple TRPs for increasing reliability;

FIG. 8 is an example of a single DCI triggered PUCCH repetitions each toward a different TRP;

FIG. 9 is an example of PUSCH repetitions each toward a different TRP;

FIG. 10 is a schematic diagram of an example network architecture illustrating a communication system connected via an intermediate network to a host computer according to the principles in the present disclosure;

FIG. 11 is a block diagram of a host computer communicating via a network node with a wireless device over an at least partially wireless connection according to some embodiments of the present disclosure;

FIG. 12 is a flowchart illustrating example methods implemented in a communication system including a host computer, a network node and a wireless device for executing a client application at a wireless device according to some embodiments of the present disclosure;

FIG. 13 is a flowchart illustrating example methods implemented in a communication system including a host computer, a network node and a wireless device for receiving user data at a wireless device according to some embodiments of the present disclosure;

FIG. 14 is a flowchart illustrating example methods implemented in a communication system including a host computer, a network node and a wireless device for receiving user data from the wireless device at a host computer according to some embodiments of the present disclosure;

FIG. 15 is a flowchart illustrating example methods implemented in a communication system including a host computer, a network node and a wireless device for receiving user data at a host computer according to some embodiments of the present disclosure;

FIG. 16 is a flowchart of an example process in a network node for signaling closed-loop power control for single and multiple transmission/reception points (TRPs);

FIG. 17 is a flowchart of an example process in a wireless device for signaling closed-loop power control for single and multiple transmission/reception points (TRPs);

FIG. 18 is a flowchart of another example process in a network node for signaling closed loop power control according to principles set forth herein;

FIG. 19 is a flowchart of another example process in a wireless device for signaling closed loop power control according to principles set forth herein;

FIG. 20 is an example of scheduling a PUSCH to a single TRP with a same DCI format for scheduling PUSCH to multiple TRPs; and

FIG. 21 is an example of signaling 2 TPC commands in a single TPC field for a PUSCH transmission toward two TRPs.

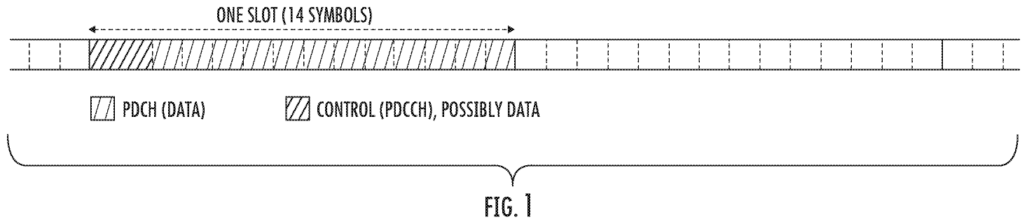

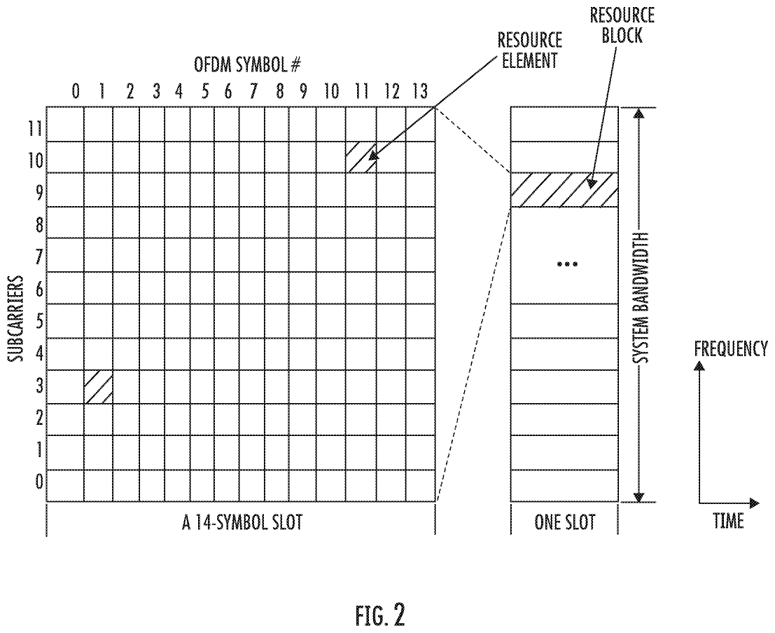

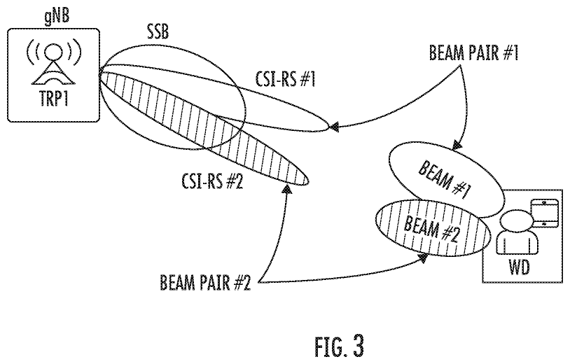

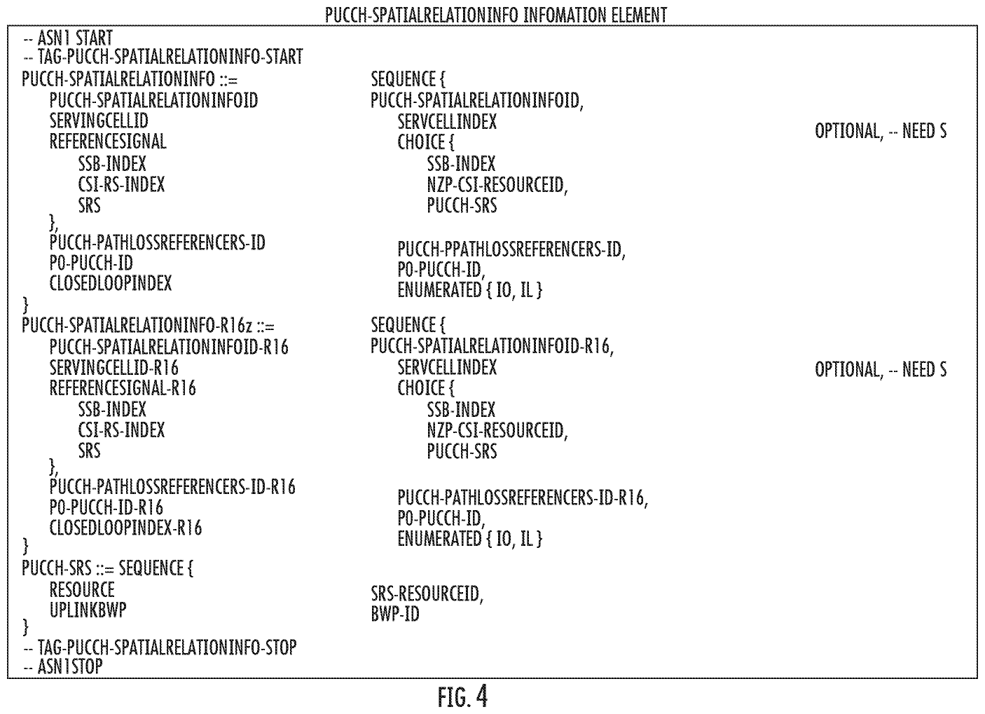

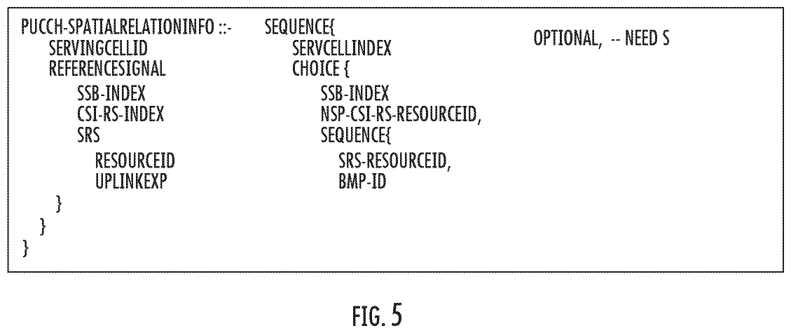

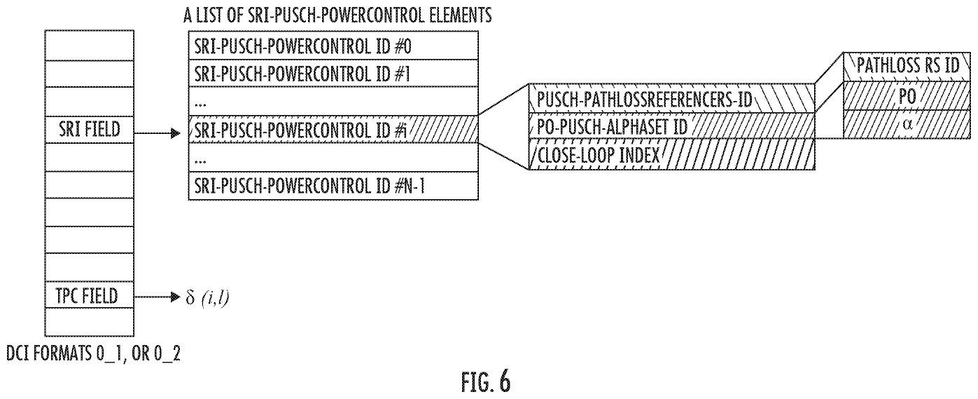

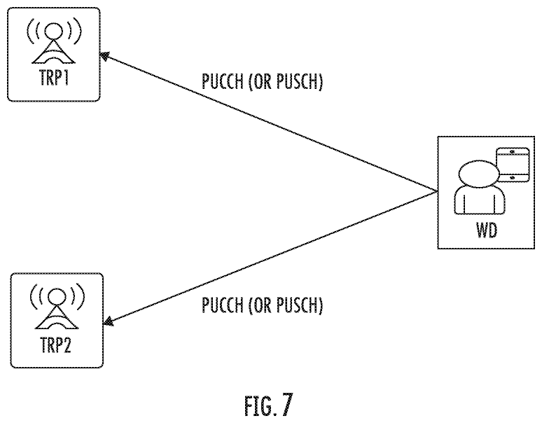

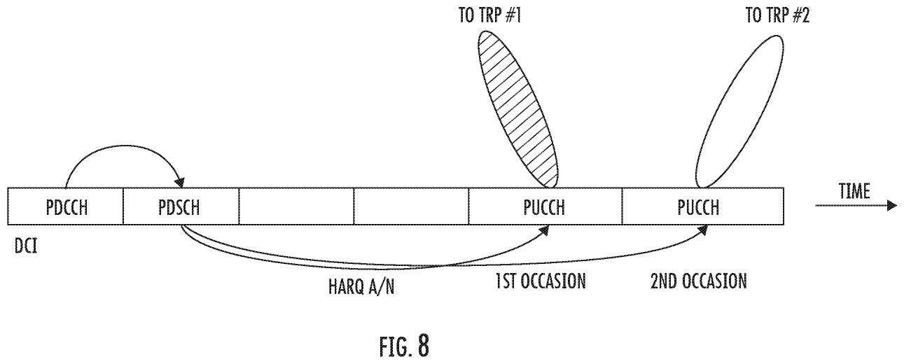

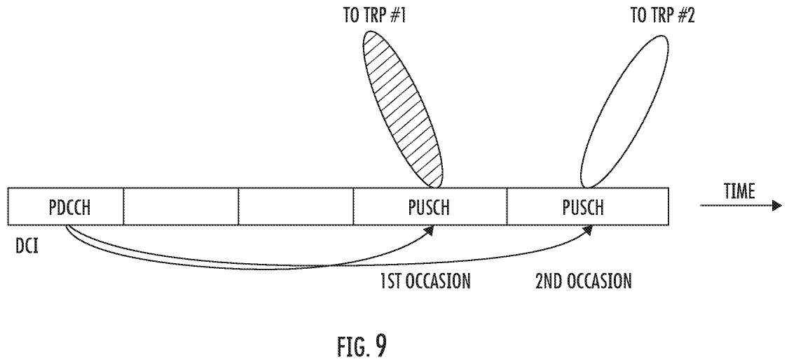

### DETAILED DESCRIPTION

Before describing in detail example embodiments, it is noted that the embodiments reside primarily in combinations of apparatus components and processing steps related to signaling closed-loop power control for single and multiple transmission/reception points (TRPs). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the network node, e.g., gNB, transmitting and receiving radio signals to/from a WD according to physical layer properties and parameters inherent to that element. In some embodiments, in Multiple Transmit/Receive Point (multi-TRP) operation, a serving cell can schedule WD from two TRPs, providing better PDSCH coverage, reliability and/or data rates. There are two different operation modes for multi-TRP: single-DCI and multi-DCI. For both modes, control of uplink and downlink operation is done by both physical layer and MAC. In single-DCI mode, WD is scheduled by the same DCI for both TRPs and in multi-DCI mode, WD is scheduled by independent DCIs from each TRP.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

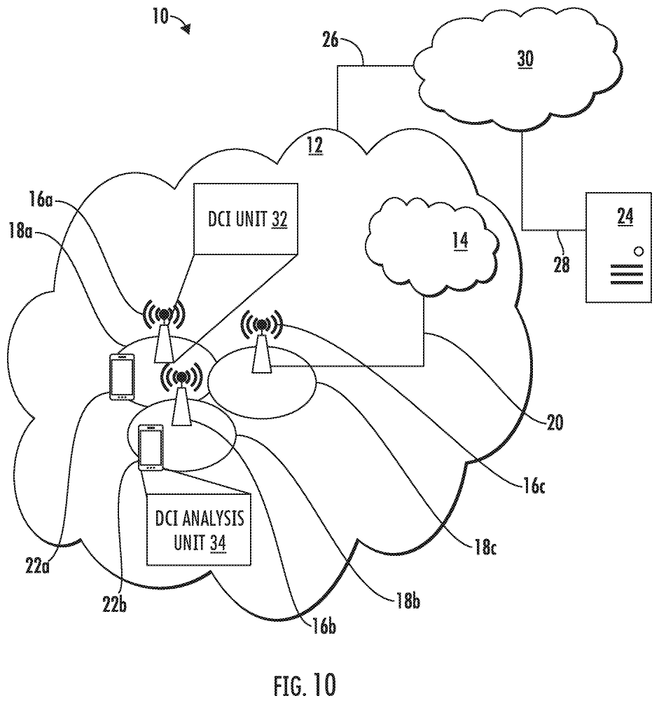

Some embodiments provide for signaling closed-loop power control for single and multiple transmission/reception points (TRPs). Returning now to the drawing figures, in which like elements are referred to by like reference numerals, there is shown in FIG. 10 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 10 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a toward the host computer 24.

A network node 16 is configured to include a DCI unit 32 which is configured to generate at least one of: a first DCI message with a first TPC command field of N bits configured to schedule a PUSCH transmission, and a second DCI message with a second TPC command field of M bits configured to schedule a PDSCH transmission. The first DCI message indicates whether the PUSCH transmission is to be transmitted to one or both of two TRPs. The second DCI message indicates whether a PUCCH resource to be used by the WD for uplink HARQ-ACK to one or both of the two TRPs according to a configuration of the PUCCH resource.

A wireless device 22 is configured to include a DCI analysis unit 34 which is configured to assume one of a single TPC command and two TPC commands are carried in a received TPC command field according to whether one of the PUSCH transmission and a PUCCH transmission is to be transmitted to only one of the first TRP and the second TRP.

Example implementations, in accordance with an embodiment, of the WD 22, network node 16 and host computer 24 discussed in the preceding paragraphs will now be described with reference to FIG. 11. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include DCI unit 32 which is configured to generate at least one of: a first DCI message with a first TPC command field of N bits configured to schedule a PUSCH transmission, and a second DCI message with a second TPC command field of M bits configured to schedule a PDSCH transmission: where the first DCI message indicates whether the PUSCH transmission is to be transmitted to one or both of two TRPs; and the second DCI message indicates whether a PUCCH resource to be used by the WD for uplink HARQ-ACK to one or both of the two TRPs according to a configuration of the PUCCH resource.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include DCI analysis unit 34 which is configured to assume one of a single TPC command and two TPC commands are carried in a received TPC command field according to whether one of the PUSCH transmission and a PUCCH transmission is to be transmitted to only one of the first TRP and the second TRP.

In some embodiments, the inner workings of the network node 16, WD 22, and host computer 24 may be as shown in FIG. 11 and independently, the surrounding network topology may be that of FIG. 10.

In FIG. 11, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 10 and 11 show various “units” such as DCI unit 32, and DCI analysis unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

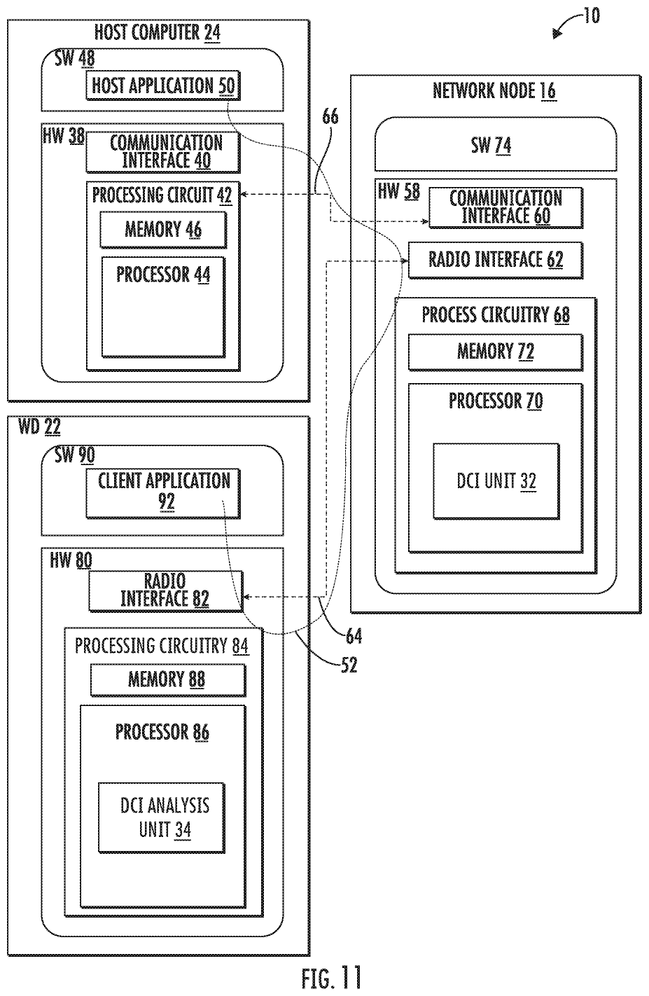

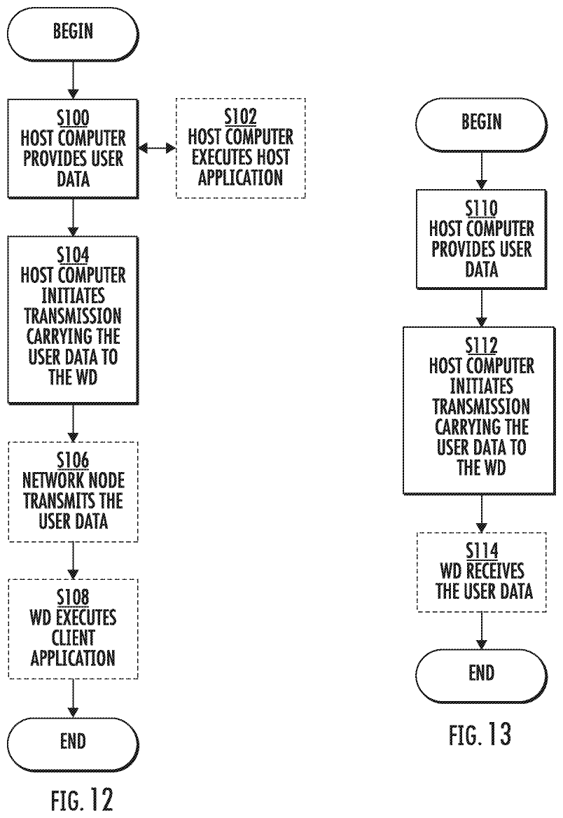

FIG. 12 is a flowchart illustrating an example method implemented in a communication system, such as, for example, the communication system of FIGS. 10 and 11, in accordance with one embodiment. The communication system may include a host computer 24, a network node 16 and a WD 22, which may be those described with reference to FIG. 11. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 13 is a flowchart illustrating an example method implemented in a communication system, such as, for example, the communication system of FIG. 10. in accordance with one embodiment. The communication system may include a host computer 24, a network node 16 and a WD 22, which may be those described with reference to FIGS. 10 and 11. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

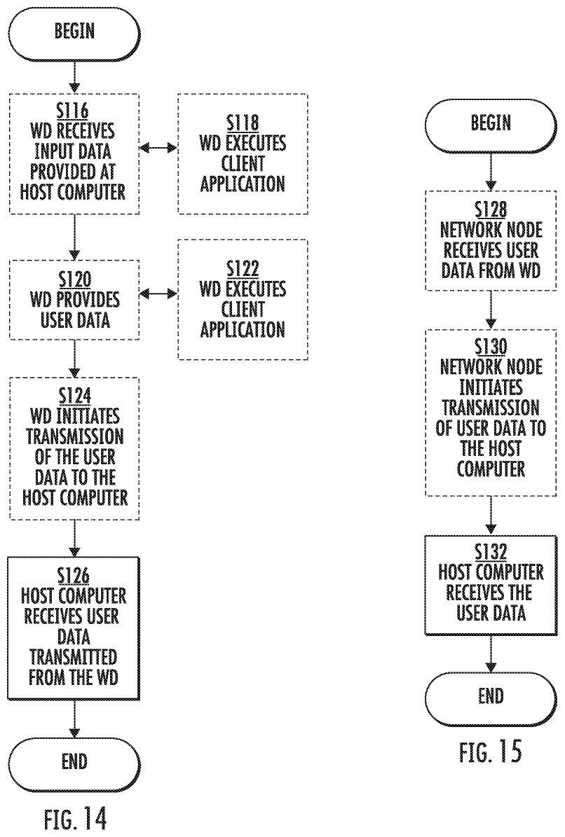

FIG. 14 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 15 is a flowchart illustrating an example method implemented in a communication system, such as, for example, the communication system of FIG. 10, in accordance with one embodiment. The communication system may include a host computer 24, a network node 16 and a WD 22, which may be those described with reference to FIGS. 10 and 11. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

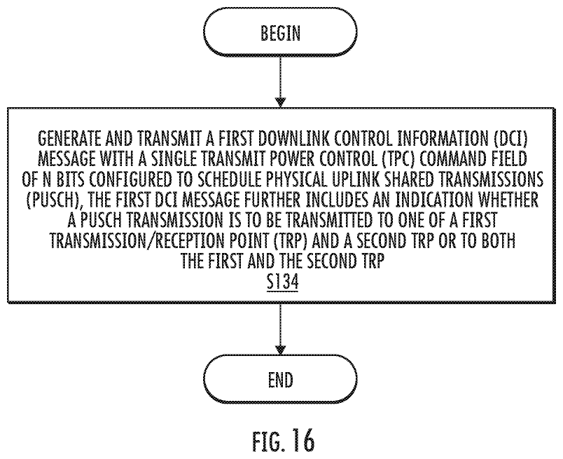

FIG. 16 is a flowchart of an example process in a network node 16 for signaling closed-loop power control for single and multiple transmission/reception points (TRPs). One or more blocks described herein may be performed by one or more elements of network node 16 such as by one or more of processing circuitry 68 (including the DCI unit 32), processor 70, radio interface 62 and/or communication interface 60. Network node 16 such as via processing circuitry 68 and/or processor 70 and/or radio interface 62 and/or communication interface 60 is configured to transmit a first downlink control information (DCI) message with a single transmit power control (TPC) command field of N bits configured to schedule physical uplink shared transmissions (PUSCH), the first DCI message further includes an indication whether a PUSCH transmission is to be transmitted to one of a first transmission/reception point (TRP) and a second TRP or to both the first and the second TRP (Block S134). In some embodiments, only some of these steps are performed by a network node 16. In some of these embodiments, results associated with steps not performed by the network node 16 are either performed elsewhere and derived and/or obtained by the network node 16 in a different manner, or they may be replaced by alternate steps.

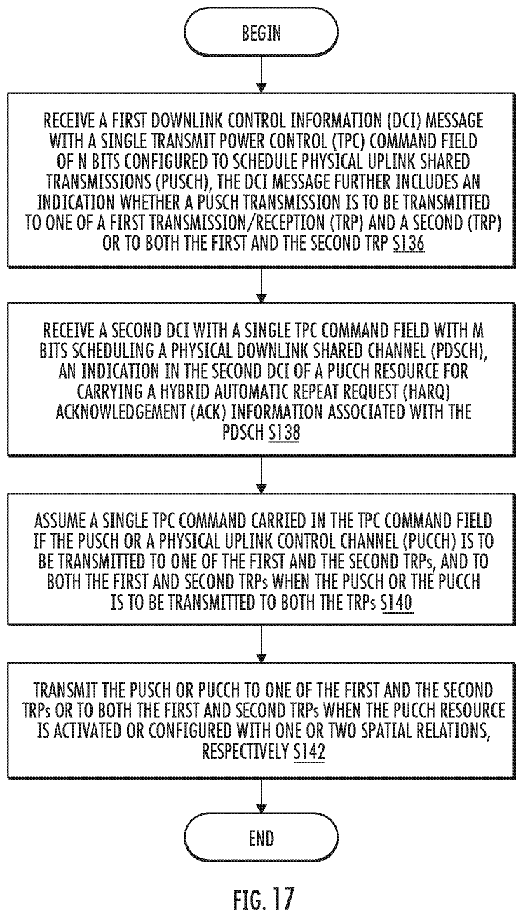

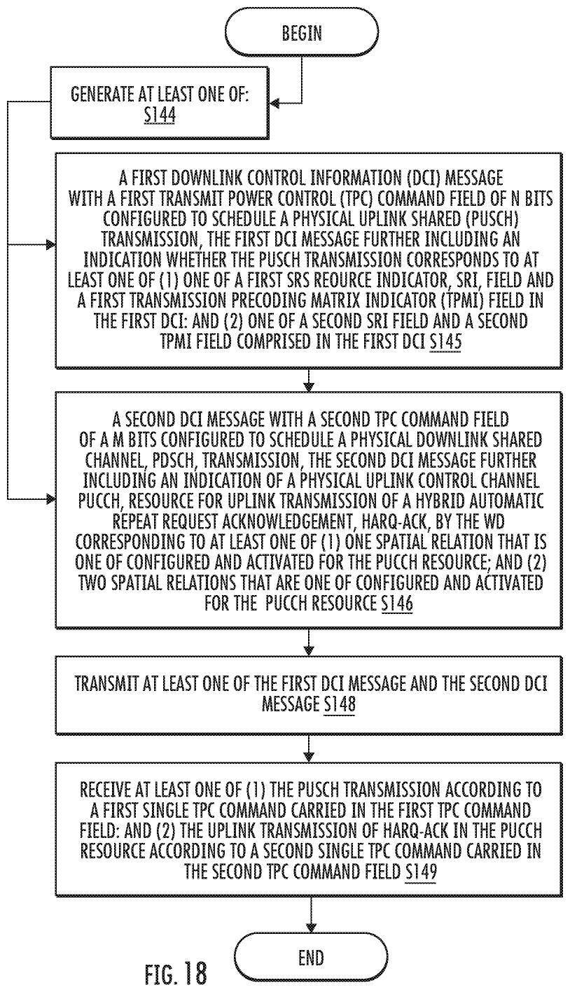

FIG. 17 is a flowchart of an example process in a wireless device 22 according to some embodiments of the present disclosure. One or more blocks described herein may be performed by one or more elements of wireless device 22 such as by one or more of processing circuitry 84 (including the DCI analysis unit 34), processor 86, radio interface 82 and/or communication interface 60. Wireless device 22 such as via processing circuitry 84 and/or processor 86 and/or radio interface 82 is configured to receive a first downlink control information (DCI) message with a single transmit power control (TPC) command field of N bits configured to schedule physical uplink shared transmissions (PUSCH), the DCI message further includes an indication whether a PUSCH transmission is to be transmitted to one of a first transmission/reception point (TRP) and a second TRP or to both the first and the second TRP (Block S136). The process also includes receiving a second DCI with a single TPC command field with M bits scheduling a physical downlink shared channel (PDSCH), an indication in the second DCI of a PUCCH resource for carrying a hybrid automatic repeat request (HARQ) Acknowledgement (ACK) information associated with the PDSCH (Block S138). The process also includes assuming a single TPC command carried in the TPC command field if the PUSCH or a physical uplink control channel (PUCCH) is to be transmitted to one of the first and the second TRPs, and to both the first and second TRPs when the first and second TPC commands carried in the TPC command field if the PUSCH or the PUCCH is to be transmitted to both the TRPs (Block S140). The process further includes transmitting the PUSCH or PUCCH to one of the first and the second TRPs or to both the first and second TRPs when the PUCCH resource is activated or configured with one or two spatial relations, respectively (Block S142). In some of these embodiments, results associated with steps not performed by the WD 22 are either performed elsewhere and derived and/or obtained by the WD 22 in a different manner, or they may be replaced by alternate steps.

FIG. 18 is a flowchart of another example process in a network node 16 for signaling closed-loop power control for single and multiple transmission/reception points (TRPs). One or more blocks described herein may be performed by one or more elements of network node 16 such as by one or more of processing circuitry 68 (including the DCI unit 32), processor 70, radio interface 62 and/or communication interface 60. Network node 16 such as via processing circuitry 68 and/or processor 70 and/or radio interface 62 and/or communication interface 60 is configured to generate (Block S144) at least one of: a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field in the first DCI; and (2) one of a second SRI field and a second TPMI field comprised in the first DCI (Block S145); and a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource (Block S146). The network node includes a radio interface (62) in communication with the processing circuitry and configure to transmit at least one the first DCI message and the second DCI message (Block S148); and receive at least one of (1) the PUSCH transmission according to a first single TPC command carried in the first TPC command field; and (2) the uplink transmission of HARQ-ACK in the PUCCH resource according to a second single TPC command carried in the second TPC command field (Block S149).

According to this aspect, in some embodiments, the PUSCH transmission corresponding to both the first SRI field and the second SRI field are according to the first single TPC command carried in the first TPC command field. In some embodiments, the PUSCH transmission corresponding to only the first SRI field are according to the first single TPC command carried in the first TPC command field. In some embodiments, the PUSCH transmission corresponding to both the first TPMI field and the second TPMI field is according to the first single TPC command carried in the first TPC command field. In some embodiments, the PUSCH transmission corresponding to only the first TPMI field is according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

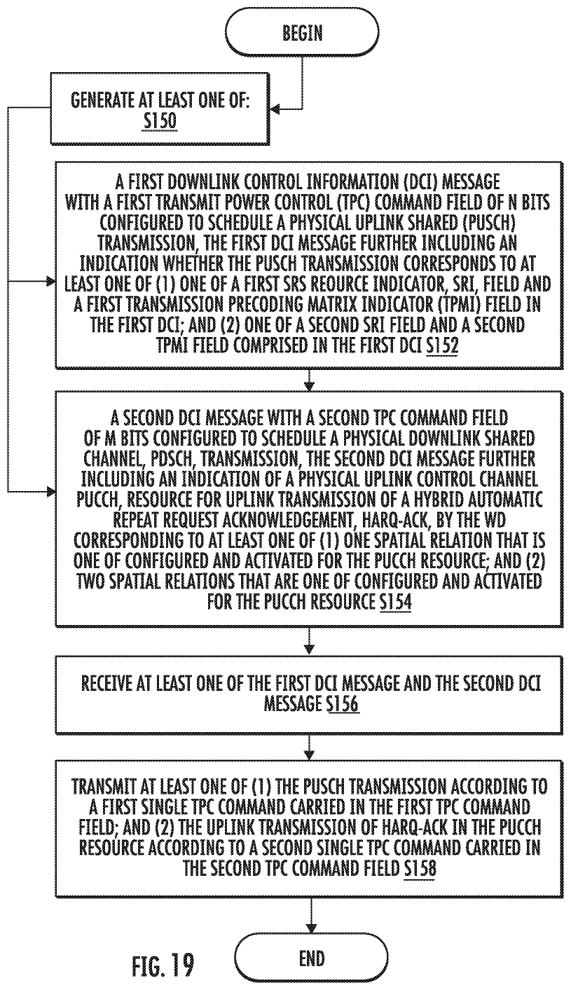

FIG. 19 is a flowchart of another example process in a wireless device 22 according to some embodiments of the present disclosure. One or more blocks described herein may be performed by one or more elements of wireless device 22 such as by one or more of processing circuitry 84 (including the DCI analysis unit 34), processor 86, radio interface 82 and/or communication interface 60. Wireless device 22 such as via processing circuitry 84 and/or processor 86 and/or radio interface 82 is configured to Receive at least one of (Block S150): a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field comprised in the first DCI (Block S152); and (2) one of a second SRI field and a second TPMI field comprised in the first DCI; a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource (Block S154). The method also includes receiving at least one of the first DCI message and the second DCI message (Block S156); and transmitting at least one of (1) the PUSCH transmission according to a first single TPC command carried in the first TPC command field; and (2) the uplink transmission of HARQ-ACK in the PUCCH resource according to a second single TPC command carried in the second TPC command field (Block S158).

According to this aspect, in some embodiments, the PUSCH transmission corresponding to both the first SRI field and the second SRI field are according to the first single TPC command carried in the first TPC command field. In some embodiments, the PUSCH transmission only corresponding to the first SRI field are according to the first single TPC command carried in the first TPC command field. In some embodiments, the PUSCH transmission corresponding to both the first TPMI field and the second TPMI field are according to the first single TPC command carried in the first TPC command field. In some embodiments, the PUSCH transmission only corresponding to the first TPMI field are according to the first single TPC command carried in the first TPC command field. In some embodiments, the uplink transmission of HARQ-ACK in the PUCCH resource corresponding to the two spatial relations is according to the second single TPC command carried in the second TPC command field. In some embodiments, the uplink transmission of HARQ-ACK in the PUCCH resource corresponding to the one spatial relation is according to the second single TPC command carried in the second TPC command field.

Having described the general process flow of arrangements of the disclosure and having provided examples of hardware and software arrangements for implementing the processes and functions of the disclosure, the sections below provide details and examples of arrangements for signaling closed-loop power control for single and multiple transmission/reception points (TRPs).

To aid understanding, two TRPs are considered in the following discussion, but it is noted that the principles and examples described herein can be extended to more than two TRPs. In other words, implementations are not limited to two TRPs.

It is assumed that a single TPC field in an UL DCI Format 0_1 or DCI Format 0_2 is used to jointly encode two TPC commands, one for each TRP, for PUSCH transmission to the two TRPs. The same DCI formats can also be used for PUSCH transmission to a single TRP.

It is assumed that whether a PUSCH is to be transmitted to a single TRP or to two TRPs is indicated in the DCI. The indication may be explicit or implicit. In the explicit case, a dedicated field may indicate whether the PUSCH is transmitted to a single TRP (e.g., TRP 1 or TRP 2), or PUSCH is transmitted to multiple TRPs (e.g., TRPs 1 and 2). In the implicit case, different codepoints in an existing field in the DCI format such as either the SRI field or the TPMI field may be used to indicate if PUSCH is transmitted to a single TRP (e.g., TRP 1 or TRP 2), or PUSCH is transmitted to multiple TRPs (e.g., TRPs 1 and 2).

Similarly, it may be assumed that a single TPC field in a DL DCI Format 1-1 or DCI Format 1_2 is used to jointly encode two TPC commands, one for each TRP, for PUCCH transmission to the two TRPs. The same DCI formats can also be used for PUCCH transmission to a single TRP.

It may be assumed that whether a PUCCH is to be transmitted to a single TRP or to two TRPs is indicated in the DCI. The indication may be explicit or implicit. In the explicit case, a dedicated field may indicate whether the PUCCH is transmitted to a single TRP (e.g., TRP 1 or TRP 2), or PUCCH is transmitted to multiple TRPs (e.g., TRPs 1 and 2). In the implicit case, different codepoints in an existing field in the

DCI format such as either the PRI field may be used to indicate if PUCCH is transmitted to a single TRP (e.g., TRP 1 or TRP 2), or PUCCH is transmitted to multiple TRPs (e.g., TRPs 1 and 2).

Note that in the PUCCH transmission, a TRP may be implicitly indicated to a WD 22 through a spatial relation or a TCI state activated for an associated PUCCH resource. Multiple spatial relations/UL TCI states may be associated with a same TRP. For PUSCH transmission, a TRP may be implicitly associated with a SRI and/or a TPMI field in a DCI.

Note that “TRPs” may themselves not be part of a wireless communication standard specification. In those cases, it is contemplated that “TCI state” or “spatial relation”, or “SRS resource set”, may be used instead, or even as part of a wireless communication standard, which are then equivalent with respect to indicating a particular TRP.

### Different TPC Encoding for Single and Multiple TRPs

In this embodiment, different encodings are used for the TPC field in a DCI depending on whether the corresponding PUCCH or PUSCH is to be transmitted to a single or two TRPs.

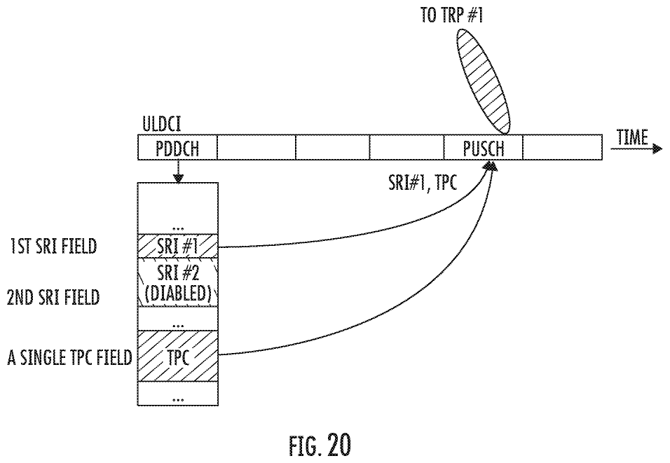

If a PUCCH or a PUSCH is scheduled to a single TRP in a DCI, the same TPC encodings as in 3GPP NR Rel-15 may be used. In other words, the WD 22 may interpret the TPC field according to 3GPP NR Rel-15 specifications of Table 1 for PUSCH and Table 2 for PUCCH. An example is shown in FIG. 20, where a PUSCH is scheduled to a single TRP with a same DCI format for scheduling PUSCH to two TRPs. The DCI contains two SRI fields and a single TPC field. Single TRP scheduling may be indicated in the two SRI fields where the 1st SRI is enabled while the 2nd SRI is disabled. In this case, legacy 3GPP Rel-15 TPC encoding would be used for the TPC field.

On the other hand, if a PUCCH or a PUSCH is scheduled to two TRPs in a DCI, a different encoding may be used in which two TPC commands are jointly encoded. Table 4 shows an example of such a joint encoding, where each code point of the TPC field indicates two values, one for each TRP.

TABLE 4
An example of mapping of a TPC command field using joint
encoding in DCI Format 0_1 and DCI Format 0_2.

| TPC Command | Power correction value | Power correction value |
|---|---|---|
| Field | [dB] for TRP#1 | [dB] for TRP#2 |
| 0 | −1 | −1 |
| 1 | 1 | 1 |
| 2 | −1 | 1 |
| 3 | 1 | −1 |

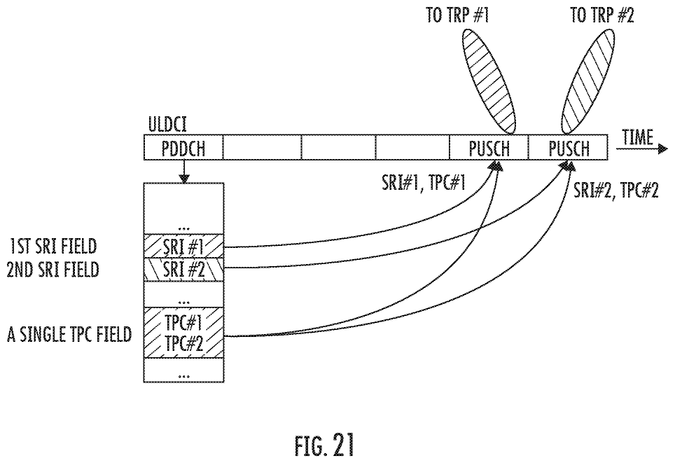

FIG. 21 is an example of scheduling a PUSCH to two TRPs, where both the SRI fields are enabled (e.g., a SRI field is enabled if the indicated codepoint is mapped to a valid SRS resource) and two TPC commands are jointly encoded in the TPC field.

Note that the above examples are shown with two SRI fields where each SRI field corresponds to a different TRP. The above examples are also equally applicable when a single SRI field is used to dynamically switch between PUSCH transmission toward a single TRP and PUSCH transmissions toward two TRPs. One possibility for dynamic switching between a single TRP and multiple TRPs for PUSCH transmission(s) with a single SRI field is to associate some codepoints of the SRI field with a single SRI value (corresponding to a PUSCH transmission toward a single TRP) and have some other codepoints of the SRI field with two SRI values (corresponding to PUSCH transmissions toward two TRPs). In one example, if the single SRI field indicates a codepoint with a single SRI value, then the single TPC field is interpreted to provide only a single TPC value and the TPC value is applied to PUSCH transmissions as shown in FIG. 20. In a second example, if the single SRI field indicates a codepoint with two SRI values, then the single TPC field is interpreted to provide two TPC values and the TPC values are applied to PUSCH transmissions as shown in FIG. 21.

In cases of PUCCH, whether the PUCCH is to be transmitted to a single TRP or two TRPs can be indicated by the number of spatial relations configured or activated in an associated PUCCH resource. If one spatial relation or no spatial relation is configured or activated for the PUCCH resource, it may be transmitted to a single TRP. Otherwise, if two spatial relations are configured, it may be transmitted to two TRPs. In cases where PUCCH is transmitted to a single TRP (i.e., the PUCCH resource indicated in DCI via the PRI field to carry the PUCCH transmission has a single spatial relation activated), then a single TPC field is interpreted to provide only a single TPC value which is applied to the PUCCH transmission. In case PUCCH is transmitted to two TRPs (i.e., the PUCCH resource indicated in DCI via the PRI field to carry the PUCCH transmissions has two spatial relations activated), then a single TPC field in the DCI is interpreted to provide two TPC values which is applied to the two PUCCH transmissions corresponding to the two spatial relations.

Although the above discussions are for TPC, the same can also be applied to other fields such as SRI and TMPI where the field may be interpreted differently for single TRP and multiple

Some embodiments may include the following:
1. Methods of uplink transmit power control in a wireless network comprising at least a network node 16 comprising a first and a second transmission and reception points, TRPs, and a user equipment, wherein each TRP is identified by a spatial relation or a sounding resource indicator, SRI, the method comprising:
receiving, by the WD 22, one of:
   a first DCI with a single TPC command field of N bits scheduling PUSCH transmission(s), and an indication in the DCI as to whether the PUSCH transmission(s) is/are to be transmitted to one of the first and the second TRPs, or to both the TRPs,
   a second DCI with a single TPC command field with M bits scheduling a PDSCH, an indication in the DCI of a PUCCH resource for carrying a HARQ Ack information associated with the PDSCH, wherein the PUCCH is to be transmitted to one of the first and the second TRPs or two TRPs if the PUCCH resource is activated or configured with one or two spatial relations, respectively; and
assuming, by the WD 22, a single TPC command carried in the TPC command field if the PUSCH or the PUCCH is to be transmitted to one of the first and the second TRPs, and two TPC commands carried in the TPC command field if the PUSCH or the PUCCH is to be transmitted to both the TRPs;
transmitting the PUSCH or the PUCCH to the one of the first and the second or both of the two TRPs according to the one or the two TPC commands, respectively.
2. The method of item 1, wherein the first DCI further comprises a first SRI or TPMI field and a second SRI or TPMI field, wherein each of the first and the second SRI or TPMI fields contains codepoints indicating that the field is disabled.
3. The method of any of items 1 to 2, wherein the PUSCH is to be transmitted to one of the first and the second TRPs if one of the two SRI or TPMI fields is disabled, and the PUSCH is to be transmitted to both of the first and the second TRPs if both of the two SRI or TPMI fields are enabled.
4. The method of any of items 1 to 3, wherein N and M are integers.
5. The method of any of items 1 to 4, wherein the assuming a single TPC command means that each code point of the TPC command field is mapped to a single power control value for a single TRP and different code points are mapped to different value.
6. The method of any of items 1 to 4, wherein the assuming two TPC commands means that each code point of the TPC command field is mapped to two power control values, one for each of the two TRPs and different code points are mapped to different pair of power control values.
7. The method of any of items 1 to 6, wherein the first DCI is one of DCI format 0_1 and DCI Format 0_2.
8. The method of any of items 1 to 6, wherein the second DCI is one of DCI format 1_0 and DCI Format 1_2.

According to one aspect, a network node 16 configured to communicate with a wireless device (WD 22), the network node 16 configured to, and/or comprising a radio interface 62 and/or comprising processing circuitry 68 configured to: generate and transmit a first downlink control information (DCI) message with a single transmit power control (TPC) command field of N bits configured to schedule physical uplink shared transmissions (PUSCH), the first DCI message further including an indication whether a PUSCH transmission is to be transmitted to one of a first transmission/reception point (TRP) and a second TRP or to both the first and the second TRP.

According to this aspect, in some embodiments, the network node 16, radio interface (62), and/or processing circuitry (68) are configured to: transmit a second DCI message with a second single TPC command field of M bits configured to schedule a physical downlink shared channel (PDSCH). In some embodiments, the second DCI message includes an indication of a physical uplink control channel (PUCCH) resource for carrying a hybrid automatic repeat request (HARQ) acknowledgement (ACK) information associated with the PDSCH, wherein the PUCCH is to transmitted to one of the first and the second TRPs or both the first and second TRPs when the PUCCH resource is activated or configured with one or two spatial relations, respectively.

According to yet another aspect, a method implemented in a network node 16 includes generating and transmitting a first downlink control information (DCI) message with a single transmit power control (TPC) command field of N bits configured to schedule physical uplink shared transmissions (PUSCH), the first DCI message further including an indication whether a PUSCH transmission is to be transmitted to one of a first transmission/reception point (TRP) and a second TRP or to both the first and the second TRP.

According to this aspect, in some embodiments, the method further includes transmitting a second DCI message with a second single TPC command field of M bits configured to schedule a physical downlink shared channel (PDSCH). In some embodiments, the second DCI message includes an indication of a physical uplink control channel (PUCCH) resource for carrying a hybrid automatic repeat request (HARQ) acknowledgement (ACK) information associated with the PDSCH, wherein the PUCCH is to transmitted to one of the first and the second TRPs or both the first and second TRPs when the PUCCH resource is activated or configured with one or two spatial relations, respectively.

According to yet another aspect, WD 22 is configured to communicate with a network node 16, the WD 22 configured to, and/or comprising a radio interface 82 and/or processing circuitry 84 configured to receive a first downlink control information (DCI) message with a single transmit power control (TPC) command field of N bits configured to schedule physical uplink shared transmissions (PUSCH), the DCI message further includes an indication whether a PUSCH transmission is to be transmitted to one of a first transmission/reception point (TRP) and a second TRP or to both the first and the second TRP; receive a second DCI with a single TPC command field with M bits scheduling a physical downlink shared channel (PDSCH), an indication in the second DCI of a PUCCH resource for carrying a hybrid automatic repeat request (HARQ) Acknowledgement (ACK) information associated with the PDSCH; assume a single TPC command carried in the TPC command field if the PUSCH or a physical uplink control channel (PUCCH) is to be transmitted to one of the first and the second TRPs, and to both the first and second TRPs when the first and second TPC commands carried in the TPC command field if the PUSCH or the PUCCH is to be transmitted to both the TRPs; and transmit the PUSCH or PUCCH to one of the first and the second TRPs or to both the first and second TRPs when the PUCCH resource is activated or configured with one or two spatial relations, respectively.

According to this aspect, in some embodiments, the first DCI further comprises a first a sounding reference signal (SRS) resource indicator (SRI) or transmission precoding matrix indicator (TPMI) field and a second SRI or TPMI field, wherein each of the first and the second SRI or TPMI fields contains codepoints indicating that the field is disabled. In some embodiments, the PUSCH is to be transmitted to one of the first and the second TRPs when one of the two SRI or TPMI fields is disabled, and the PUSCH is to be transmitted to both of the first and the second TRPs if both of the two SRI or TPMI fields are enabled.

According to another aspect, a method implemented in a wireless device (WD 22), includes: receiving a first downlink control information (DCI) message with a single transmit power control (TPC) command field of N bits configured to schedule physical uplink shared transmissions (PUSCH), the DCI message further includes an indication whether a PUSCH transmission is to be transmitted to one of a first transmission/reception point (TRP) and a second TRP or to both the first and the second TRP; receiving a second DCI with a single TPC command field with M bits scheduling a physical downlink shared channel (PDSCH), an indication in the second DCI of a PUCCH resource for carrying a hybrid automatic repeat request (HARQ) Acknowledgement (ACK) information associated with the PDSCH; assuming a single TPC command carried in the TPC command field if the PUSCH or a physical uplink control channel (PUCCH) is to be transmitted to one of the first and the second TRPs, and to both the first and second TRPs when the PUSCH or the PUCCH is to be transmitted to both the TRPs; and transmitting the PUSCH or PUCCH to one of the first and the second TRPs or to both the first and second TRPs when the PUCCH resource is activated or configured with one or two spatial relations, respectively.

According to this aspect, in some embodiments, the first DCI further comprises a first a sounding reference signal (SRS) resource indicator (SRI) or transmission precoding matrix indicator (TPMI) field and a second SRI or TPMI field, wherein each of the first and the second SRI or TPMI fields contains codepoints indicating that the field is disabled. In some embodiments, the PUSCH is to be transmitted to one of the first and the second TRPs when one of the two SRI or TPMI fields is disabled, and the PUSCH is to be transmitted to both of the first and the second TRPs if both of the two SRI or TPMI fields are enabled.

Some embodiments may include one or more of the following:
Embodiment A1. A network node configured to communicate with a wireless device (WD), the network node configured to, and/or comprising a radio interface and/or comprising processing circuitry configured to:
   generate and transmit a first downlink control information (DCI) message with a single transmit power control (TPC) command field of N bits configured to schedule physical uplink shared transmissions (PUSCH), the first DCI message further including an indication whether a PUSCH transmission is to be transmitted to one of a first transmission/reception point (TRP) and a second TRP or to both the first and the second TRP.
Embodiment A2. The network node of Embodiment A1, wherein the network node, radio interface, and/or processing circuitry are further configured to:
   transmit a second DCI message with a second single TPC command field of M bits configured to schedule a physical downlink shared channel (PDSCH).
Embodiment A3. The network node of Embodiment A2, wherein the second DCI message includes an indication of a physical uplink control channel (PUCCH) resource for carrying a hybrid automatic repeat request (HARQ) acknowledgement (ACK) information associated with the PDSCH, wherein the PUCCH is to transmitted to one of the first and the second TRPs or both the first and second TRPs when the PUCCH resource is activated or configured with one or two spatial relations, respectively.
Embodiment B1. A method implemented in a network node, the method comprising:
   generating and transmitting a first downlink control information (DCI) message with a single transmit power control (TPC) command field of N bits configured to schedule physical uplink shared transmissions (PUSCH), the first DCI message further including an indication whether a PUSCH transmission is to be transmitted to one of a first transmission/reception point (TRP) and a second TRP or to both the first and the second TRP.
Embodiment B2. The method of Embodiment B1, further comprising transmitting a second DCI message with a second single TPC command field of M bits configured to schedule a physical downlink shared channel (PDSCH).
Embodiment B3. The method of Embodiment B2, wherein the second DCI message includes an indication of a physical uplink control channel (PUCCH) resource for carrying a hybrid automatic repeat request (HARQ) acknowledgement (ACK) information associated with the PDSCH, wherein the PUCCH is to transmitted to one of the first and the second TRPs or both the first and second TRPs when the PUCCH resource is activated or configured with one or two spatial relations, respectively.
Embodiment C1. A wireless device (WD) configured to communicate with a network node, the WD configured to, and/or comprising a radio interface and/or processing circuitry configured to:
   receive a first downlink control information (DCI) message with a single transmit power control (TPC) command field of N bits configured to schedule physical uplink shared transmissions (PUSCH), the DCI message further includes an indication whether a PUSCH transmission is to be transmitted to one of a first transmission/reception point (TRP) and a second TRP or to both the first and the second TRP;
   receive a second DCI with a single TPC command field with M bits scheduling a physical downlink shared channel (PDSCH), an indication in the second DCI of a PUCCH resource for carrying a hybrid automatic repeat request (HARQ) Acknowledgement (ACK) information associated with the PDSCH;
   assume a single TPC command carried in the TPC command field if the PUSCH or a physical uplink control channel (PUCCH) is to be transmitted to one of the first and the second TRPs, and to both the first and second TRPs when the first and second TPC commands carried in the TPC command field if the PUSCH or the PUCCH is to be transmitted to both the TRPs; and
   transmit the PUSCH or PUCCH to one of the first and the second TRPs or to both the first and second TRPs when the PUCCH resource is activated or configured with one or two spatial relations, respectively.
Embodiment C2. The WD of Embodiment C1, wherein the first DCI further comprises a first a sounding reference signal (SRS) resource indicator (SRI) or transmission precoding matrix indicator (TPMI) field and a second SRI or TPMI field, wherein each of the first and the second SRI or TPMI fields contains codepoints indicating that the field is disabled.
Embodiment C3. The WD of Embodiment C2, wherein the PUSCH is to be transmitted to one of the first and the second TRPs when one of the two SRI or TPMI fields is disabled, and the PUSCH is to be transmitted to both of the first and the second TRPs if both of the two SRI or TPMI fields are enabled.
Embodiment D1. A method implemented in a wireless device (WD), the method comprising:
   receiving a first downlink control information (DCI) message with a single transmit power control (TPC) command field of N bits configured to schedule physical uplink shared transmissions (PUSCH), the DCI message further includes an indication whether a PUSCH transmission is to be transmitted to one of a first transmission/reception point (TRP) and a second TRP or to both the first and the second TRP;
   receiving a second DCI with a single TPC command field with M bits scheduling a physical downlink shared channel (PDSCH), an indication in the second DCI of a PUCCH resource for carrying a hybrid automatic repeat request (HARQ) Acknowledgement (ACK) information associated with the PDSCH;
   assuming a single TPC command carried in the TPC command field if the PUSCH or a physical uplink control channel (PUCCH) is to be transmitted to one of the first and the second TRPs, and to both the first and second TRPs when the PUSCH or the PUCCH is to be transmitted to both the TRPs; and
   transmitting the PUSCH or PUCCH to one of the first and the second TRPs or to both the first and second TRPs when the PUCCH resource is activated or configured with one or two spatial relations, respectively.
Embodiment D2. The method of Embodiment D1, wherein the first DCI further comprises a first a sounding reference signal (SRS) resource indicator (SRI) or transmission precoding matrix indicator (TPMI) field and a second SRI or TPMI field, wherein each of the first and the second SRI or TPMI fields contains codepoints indicating that the field is disabled.
Embodiment D3. The method of Embodiment D2, wherein the PUSCH is to be transmitted to one of the first and the second TRPs when one of the two SRI or TPMI fields is disabled, and the PUSCH is to be transmitted to both of the first and the second TRPs if both of the two SRI or TPMI fields are enabled.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising
processing circuitry configured to generate at least one of:
a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field in the first DCI; and (2) one of a second SRI field and a second TPMI field comprised in the first DCI; and
a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD (22) corresponding to at least one of (1) one spatial relation that is one of configured and activated for the PUCCH resource; and (2) two spatial relations that are one of configured and activated for the PUCCH resource; and
a radio interface (62) in communication with the processing circuitry (68) and configured to transmit at least one the first DCI message and the second DCI message; and receive at least one of (1) the PUSCH transmission according to a first single TPC command carried in the first TPC command field; and (2) the uplink transmission of HARQ-ACK in the PUCCH resource according to a second single TPC command carried in the second TPC command field.

2. The network node of claim 1, wherein the PUSCH transmission corresponding to both the first SRI field and the second SRI field are according to the first single TPC command carried in the first TPC command field.

3. The network node of claim 1, wherein the PUSCH transmission corresponding to only the first SRI field are according to the first single TPC command carried in the first TPC command field.

4. The network node of claim 1, wherein the PUSCH transmission corresponding to both the first TPMI field and the second TPMI field is according to the first single TPC command carried in the first TPC command field.

5. The network node of claim 1, wherein the PUSCH transmission corresponding to only the first TPMI field is according to the first single TPC command carried in the first TPC command field.

6. The network node of claim 1, wherein the uplink transmission of HARQ-ACK in the PUCCH resource corresponding to the two spatial relations is according to the second single TPC command carried in the second TPC command field.

7. The network node of claim 1, wherein the uplink transmission of HARQ-ACK in the PUCCH resource corresponding to the one spatial relation is according to the second single TPC command carried in the second TPC command field.

8. A method in a network node configured to communicate with a wireless device, WD, the method comprising:
generating at least one of:
a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field in the first DCI; and (2) one of a second SRI field and a second TPMI field comprised in the first DCI; and
a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured and activated for the PUCCH resource; and (2) two spatial relations that are one of configured and activated for the PUCCH resource;
transmitting at least one of the first DCI message and the second DCI message; and
receiving at least one of (1) the PUSCH transmission according to a first single TPC command carried in the first TPC command field; and (2) the uplink transmission of HARQ-ACK in the PUCCH resource according to a second single TPC command carried in the second TPC command field.

9. The method of claim 8, wherein the PUSCH transmission corresponding to both the first SRI field and the second SRI field are according to the first single TPC command carried in the first TPC command field.

10. The method of claim 8, wherein the PUSCH transmission corresponding to only the first SRI field are according to the first single TPC command carried in the first TPC command field.

11. The method of claim 8, wherein the PUSCH transmission corresponding to both the first TPMI field and the second TPMI field is according to the first single TPC command carried in the first TPC command field.

12. The method of claim 8, wherein the PUSCH transmission corresponding to only the first TPMI field is according to the first single TPC command carried in the first TPC command field.

13. The method of claim 8, wherein the uplink transmission of HARQ-ACK in the PUCCH resource corresponding to the two spatial relations is according to the second single TPC command carried in the second TPC command field.

14. The method of claim 8, wherein the uplink transmission of HARQ-ACK in the PUCCH resource corresponding to the one spatial relation is according to the second single TPC command carried in the second TPC command field.

15. A wireless device, WD, configured to communicate with a network node, the WD comprising:
a radio interface configured to receive at least one of:
a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field comprised in the first DCI; and (2) one of a second SRI field and a second TPMI field comprised in the first DCI; and
a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD corresponding to at least one of (1) one spatial relation that is one of configured or activated for the PUCCH resource; and (2) two spatial relations that are one of configured and activated for the PUCCH resource; and
the radio interface being further configured to:
receive at least one of the first DCI message and the second DCI message; and
transmit at least one of (1) the PUSCH transmission according to a first single TPC command carried in the first TPC command field; and (2) the uplink transmission of HARQ-ACK in the PUCCH resource according to a second single TPC command carried in the second TPC command field.

16. The WD of claim 15, wherein the PUSCH transmission corresponding to both the first SRI field and the second SRI field are according to the first single TPC command carried in the first TPC command field.

17. The WD of claim 15, wherein the PUSCH transmission only corresponding to the first SRI field are according to the first single TPC command carried in the first TPC command field.

18. The WD of claim 15, wherein the PUSCH transmission corresponding to both the first TPMI field and the second TPMI field are according to the first single TPC command carried in the first TPC command field.

19. The WD of claim 15, wherein the PUSCH transmission only corresponding to the first TPMI field are according to the first single TPC command carried in the first TPC command field.

20. The WD of claim 15, wherein the uplink transmission of HARQ-ACK in the PUCCH resource corresponding to the two spatial relations is according to the second single TPC command carried in the second TPC command field.

21. The WD of claim 15, wherein the uplink transmission of HARQ-ACK in the PUCCH resource corresponding to the one spatial relation is according to the second single TPC command carried in the second TPC command field.

22. A method in a wireless device, WD, configured to communicate with a network node, the method comprising:
receiving at least one of:
a first downlink control information (DCI) message with a first transmit power control (TPC) command field of N bits configured to schedule a physical uplink shared (PUSCH) transmission, the first DCI message further including an indication whether the PUSCH transmission corresponds to at least one of (1) one of a first SRS resource indicator, SRI, field and a first transmission precoding matrix indicator (TPMI) field comprised in the first DCI; and (2) one of a second SRI field and a second TPMI field comprised in the first DCI ($152); and
a second DCI message with a second TPC command field of M bits configured to schedule a physical downlink shared channel, PDSCH, transmission, the second DCI message further including an indication of a physical uplink control channel, PUCCH, resource for uplink transmission of a hybrid automatic repeat request acknowledgement, HARQ-ACK, by the WD (22) corresponding to at least one of (1) one spatial relation that is one of configured and activated for the PUCCH resource; and (2) two spatial relations that are one of configured and activated for the PUCCH resource;
receiving at least one of the first DCI message and the second DCI message; and
transmitting at least one of (1) the PUSCH transmission according to a first single TPC command carried in the first TPC command field; and (2) the uplink transmission of HARQ-ACK in the PUCCH resource according to a second single TPC command carried in the second TPC command field.

23. The method of claim 21, wherein the PUSCH transmission corresponding to both the first SRI field and the second SRI field are according to the first single TPC command carried in the first TPC command field.

24. The method of claim 21, wherein the PUSCH transmission only corresponding to the first SRI field are according to the first single TPC command carried in the first TPC command field.

25. The method of claim 21, wherein the PUSCH transmission corresponding to both the first TPMI field and the second TPMI field are according to the first single TPC command carried in the first TPC command field.

26. The method of claim 21, wherein the PUSCH transmission only corresponding to the first TPMI field are according to the first single TPC command carried in the first TPC command field.

27. The method of claim 21, wherein the uplink transmission of HARQ-ACK in the PUCCH resource corresponding to the two spatial relations is according to the second single TPC command carried in the second TPC command field.

28. The method of claim 21, wherein the uplink transmission of HARQ-ACK in the PUCCH resource corresponding to the one spatial relation is according to the second single TPC command carried in the second TPC command field.
